(19) United States
(12) Patent Application Publication
(10) Pub. No.: US 2006/0098573 A1
(43) Pub. Date: May 11, 2006

(54) System and method for the virtual aggregation of network links

(76) Inventors: John C. Beer, San Diego, CA (US); Ronald D. Fellman, San Diego, CA (US)

Correspondence Address: DALINA LAW GROUP, P.C., 7910 IVANHOE AVE. #325, LA JOLLA, CA, 92037, US

(21) Appl. No.: 11/269,432

(22) Filed: Nov. 8, 2005

Related U.S. Application Data
(60) Provisional application No. 60/626,243, filed on Nov. 8, 2004.

(51) Int. Cl. H04L 12/28

(52) U.S. Cl. 370/230; 370/537

(57) ABSTRACT

A system and method for virtual link aggregation for combining network links of various types and speeds to increase throughput and reliability for packetized transport. In contrast with physical port trunking, the system does not require direct control over ports or network interfaces. Instead, the system rewrites packet addresses and works through existing networking equipment, without requiring any new or special protocols, processing, or equipment within the network. The system works through low-level rerouting by rewriting hardware addresses and/or high-level routing by rewriting logical addresses. Thus packets are redirected through multiple routes to a common destination via alternate gateways and links. Different algorithms may be employed to balance the load on each link and determine an optimal route for each packet. Embodiments may also employ packet flow or stream identification and thereby only provide link aggregation for a specified set of packet flows.

This application takes priority from U.S. Provisional Patent Application Ser. No. 60/626,243, entitled “SYSTEM AND METHOD FOR THE VIRTUAL AGGREGATION OF NETWORK LINKS”, filed Nov. 8, 2004 which is hereby incorporated herein by reference.

### BACKGROUND OF THE INVENTION

1. Field of the Invention

Embodiments of the invention relate to computer networks. Specifically, but not by way of limitation, embodiments of the invention relate to a system and method for combining multiple packetized network connections and treating the resulting aggregation of connections as a single virtual network link. The aggregation of network connections may employ a diverse set of routes to a common destination and may comprise network connections having a heterogeneous set of connection mechanisms, speeds, and properties. Optionally, embodiments of this invention may include a means of trunking that recognizes packets belonging to a specified flow and redistribute the packets among multiple paths to a common destination, where they are reassembled back into a single flow.

2. Description of the Related Art

The current state of the Internet has been likened to a superhighway with dirt on-ramps. At present, cost-efficient broadband connections, such as DSL and DOCSIS (Data Over Cable Service Interface Specification), generally limit upstream throughput to 384 Kbps, despite the fact that DSL and DOCSIS are capable of speeds rivaling or exceeding DS-1 service. To obtain throughputs of 1.5 Mbps or faster usually requires DS-1 or Frame-Relay service that costs many times more on a price per throughput basis. Thus, economic incentives exist for providing a mechanism that can combine multiple low cost connections to provide higher aggregate throughput. This combining or bonding of multiple physical links into a single logical link is called port trunking or link aggregation.

In addition to economic incentives, reliability concerns provide another reason for link aggregation. A single connection handling all network traffic has the potential for a single point of failure. Aggregating multiple links provides connection diversity and redundancy that can significantly improve system availability and reliability. IEEE 802.3ad [1] defines a standard for Ethernet link aggregation and is part of a high availability solution for Linux. In addition to being a part of common operating systems (OS), such as Linux, standard Ethernet switches and other networking equipment also implement IEEE 802.3ad. Personal computers (PC) with IEEE 802.3ad in the OS can take advantage of multiple Ethernet ports, through either the installation of multiple network adapters or by means of network adapter cards with multiple independent Ethernet ports to provide increased communications throughput and reliability.

Local exchange carriers (LECs) who provide Internet access may deploy network access using physical port trunking when a customer requests a throughput rate that exceeds the capacity of a single DS-1 link by bonding DS-1 channels to provide higher throughputs. As another example of trunking, ISDN can bond two 64 Kbps data channels to form a single 128 Kbps channel.

Although LECs offer physical trunking for ISDN, Frame-Relay, and Digital System (DS) circuits (eg., DS-1 and DS-3) to offer users a single aggregated network link that preserves packet ordering and offers a high quality of service, they do not offer such trunking service for DSL lines or cellular data connections. In general, cellular data links, DSL, and cable modem connections cannot bond with other data links, or even other similar links to form a single higher-throughput link. Thus despite the wide deployment of 2.488 Gbps OC-48 links and 9.953 Gbps OC-192 links within the Internet backbone, our original adage holds. We still must contend with “dirt off-ramps” for Internet connectivity.

The demands of streaming video further aggravate these throughput issues. Networked video streams generally require throughput capacity that exceeds the speed of a single DSL link, and often even that of a DS-1 link. Video and audio streams also have the requirement that their packets must be received at a destination node in their original order. Out of order media packets wreak havoc on video and audio playback unless packet reordering means are provided at the receiving node. Yet the use of dynamic load balancing within a network, as is generally supported within the Internet, may corrupt packet ordering or introduce significant packet jitter and thereby impair playback of a media stream.

In an attempt to address the throughput issue for media streams, systems that use ISDN interfaces, which generally include most video conferencing equipment, provide Quad Basic Rate Interfaces (Quad BRI) that uses physical trunking to bind 4 ISDN BRI lines into a single 512 Kbps logical link. However because such interfaces rely upon the binding capability of ISDN channels, they do not scale to other types of interfaces, such as multiple DSL links, multiple cell-phone connections, or a combination of several different types of connections that might provide link diversity and increased throughput. This sort of binding is also limited specifically to BRI and PRI connections supported by most video conferencing equipment.

In order to expand the ability to aggregate data links and provide enhanced throughput and reliability for mobile environments, researchers at the University of Chicago at Urbana-Champagne have developed a new protocol, MMTP: Multimedia Multiplexing Transport Protocol [2] to aggregate multiple cooperating mobile phones into a single virtual channel. While MMTP can provide a high throughput wireless connection from the aggregation of many low throughput cellular data channels, it requires modifications to the cellular system's base stations as well as the mobile phones and cellular data modem cards. Researchers at Hewlett-Packard Labs in Palo Alto have recently proposed a similar cellular data link aggregation system to send data files at higher speeds [3]. This proposed system also appears to rely upon a special protocol that must be recognized by the network equipment, in this case the cellular system's base station. However, the only available reference to this research does not provide enough detail to understand how this proposed system would work and does not teach any implementations for this proposed system.

While the foregoing demonstrates an increase in interest concerning new and more flexible forms of link aggregation, link aggregation systems also create new challenges. Variable link delays may result in out-of-sequence packet ordering. Network congestion from the merging of traffic from multiple links can result in queue overflow and a resulting packet loss. The reliance on many links to form an aggregate virtual link increases the chance of packet loss because of the increased probability of a single link failing. Live streaming media, such as video and audio, are particularly sensitive to such link impairments. Thus, without Quality of Service (QoS) mechanisms to recover lost packets, restore packet order, and the original stream timing, link aggregation can severely degrade the performance of live streaming systems.

Many legacy IP video conferencing systems and streaming media servers do not contain adequate QoS mechanisms, if any at all, for Internet or wireless IP network transport. Thus, systems incorporating link aggregation and their attendant network impairment issues particularly require the incorporation of QoS mechanisms. However to our knowledge, no current virtual link aggregation mechanisms incorporate any such QoS mechanisms.

### BRIEF SUMMARY OF THE INVENTION

Embodiments of the invention provide a system and enable a method for virtual link aggregation that combines network links of various types and speeds to increase throughput and reliability for packetized transport. In contrast with physical port trunking, the link aggregation of this invention does not require direct control over ports or network interfaces. Instead, embodiments of this invention rewrite packet addresses and thereby remotely control packet routing.

The virtual link aggregation of the present invention works through existing networking equipment, without requiring any new or special protocols, processing, or equipment within the network. Embodiments of this virtual link aggregation may work via combinations of low-level and high-level rerouting: low-level rerouting by rewriting hardware addresses, and high-level routing by rewriting logical addresses. However in both cases, this virtual link aggregation redirects packets through a multitude of routes to a common destination via sets of alternate gateways and links.

Various embodiments of the invention may use different algorithms to balance the loading on each link and determine an optimal route for each packet; with the result that link loading among the specified set of alternative routes is substantially in balance. In another improvement, embodiments of the invention may optionally include a means for packet flow or stream identification and thereby only provide link aggregation for a specified set of packet flows.

In an embodiment of the invention involving Internet Protocol routing over an Ethernet physical layer, a routing control unit rewrites the low-level Ethernet destination address corresponding to alternate ports of each of the links to aggregate onto successive packets according to a load balancing algorithm. Other embodiments of the invention may use other means of routing successive packets to each of a series of alternate routes, according to an algorithm that balances the loading on each link.

### BRIEF DESCRIPTION OF THE DRAWINGS

FIG. 1 shows a system diagram showing multiple wide-area network (WAN) links and a transmitting network node that includes link aggregation processing for the links connecting the network node to a WAN, such as the Internet. Link processing in the network node treats these multiple WAN links as a single outbound virtual link.

FIG. 2 shows a system diagram showing multiple WAN links connecting a wide-area network to a receiving network node that includes link aggregation processing. Using multi-homed IP addressing, a receiving network node having multiple IP addresses would be capable of treating the multiple WAN links as a single inbound virtual link.

FIG. 3A shows a system example showing both outbound and inbound virtual link aggregation.

FIG. 3B shows packet routing corresponding to the example of FIG. 3A showing packet hardware address routing for transmit to a WAN and packet IP addresses for receive routing from a WAN.

FIG. 4 shows high-level pseudo-code of Link Aggregator 10 of FIG. 1.

FIG. 5 shows pseudo-code of optional Flow Identifier 100 of FIG. 1.

FIG. 6 shows Pseudo-code of Load Balancing and Link Selection Unit 1011 of Packet Processor 101 of FIG. 1.

FIG. 7 shows Pseudo-code of Packet Processor 101 of Link Aggregator 10 of FIG. 1 including a link modeling function that models queue levels and current loading of each link.

FIG. 8 shows processing steps for an embodiment of the invention.

### DETAILED DESCRIPTION OF THE INVENTION

Embodiments of the invention implement a method for virtual link aggregation that provides high-throughput and reliable transport of data packets, including but not limited to, video streams and other time and order sensitive packet flows. The ability to aggregate multiple low speed and low reliability links becomes especially important in the transport of video, audio, and other time and order-sensitive packet streams that require high throughput. Video streams, in particular, often require more throughput than a single low-cost broadband link, such as DSL and cable-modem, can provide. Any mechanism that can couple multiple low-cost links has the potential to provide significant cost advantages in the provisioning of streaming video services.

Because embodiments of this invention rewrite packet destination addresses, they control the routing of each packet on a per-packet basis rather than by directly controlling network ports or link interfaces. By this indirect control of packet routing, embodiments of the invention provide a mechanism for virtual link aggregation that can work through existing networking equipment, without requiring any new or special protocols, downstream packet processing, or equipment within the network. In contrast, other link aggregation mechanisms, such as IEE 802.3ad and MMTP require new protocols or special network equipment to function.

Embodiments of this virtual link aggregation may work through combinations of low-level rerouting by rewriting hardware addresses, and high-level routing by rewriting logical addresses. However in both cases, this virtual link aggregation redirects packets, or in some embodiments flows of media streams, through a multitude of routes to a common destination via sets of alternate gateways and links. Various embodiments of the invention may use different algorithms to balance the loading on each link and determine an optimal route for each packet; with the result that link loading among routes within the set of alternative routes is substantially in balance among the packets of the specified flows or streams of related packets.

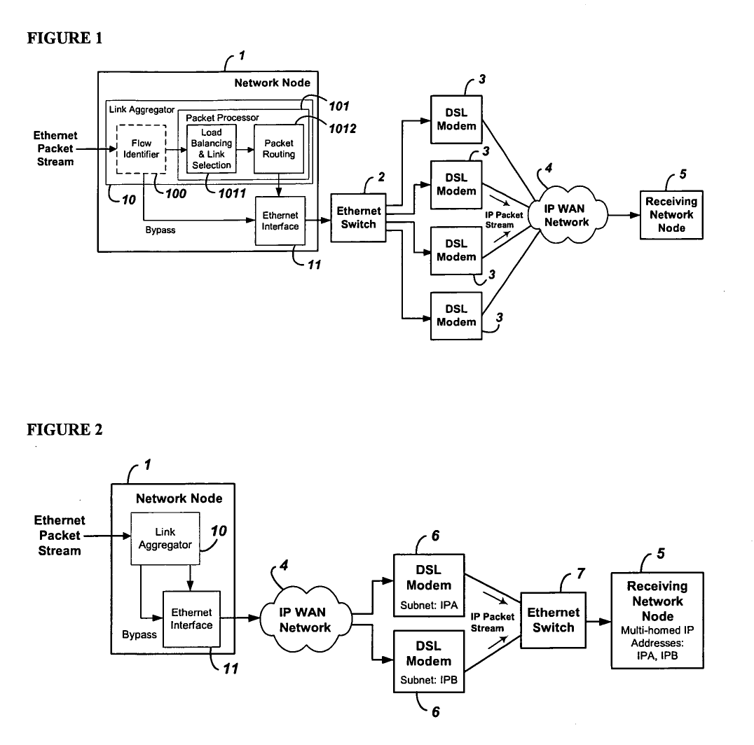

FIG. 1 provides an example of one embodiment of the invention for aggregating traffic traveling outbound from Network Node 1 through multiple links to a Wide-Area Network 4 (WAN). Examples of Wide-Area Network 4 include, but are not limited to, the Internet, a private IP backbone, and the network controlled by a wireless base station. In this example, traffic may either originate within Network Node 1, or alternatively, enter Network Node 1 from an external source. In either case, Link Aggregator 10 handles all incoming packets before being output through a network interface, in this example, Ethernet Interface 11. Packets entering Network Node I may comprise random data packets, or comprise of flows of media packets.

For embodiments that handle media streams, an optional Flow Identifier 100 within Link Aggregator 10 may identify and filter incoming packets that are part of a selected set of streams to only provide virtual link aggregation processing for these packets. In the case of packet flows, Flow Identifier 100 would bypass, from further processing by Packet Processor 101, any packets that are not part of a selected flow, and send these packets directly to Ethernet Interface 11. For all other packets, Load Balancing and Link Selection Unit 1011 would use information about the throughput capacity of each link along with packet size information and the history of previous routing decisions to select a link for routing each packet. Load Balancing and Link Selection Unit 1011 functions to choose the route for each packet that would best balance the throughput loading among all links comprising the virtual link aggregate. Link Aggregator 104 may be configured with information concerning all possible WAN links along with a list of which WAN links to include as part of the virtual link aggregate.

Packet Routing Unit 1012 takes routing information from Link Selector 1011 and rewrites the destination address for each packet as appropriate to route packets through the chosen links. In the example of FIG. 1, network interfaces such as DSL Modems 3 comprise the set of links for the virtual link aggregate, and Ethernet Switch 2 forwards packets from Network Node I to DSL Modems 3. However, any set of WAN links can replace DSL Modem Links 3. Other examples include mobile phone data modems, cable modems, T1 links, and various combinations of these or other types of wireline and wireless WAN links. A repeater or hub can replace Ethernet Switch 2. Furthermore, alternate embodiments of the invention may use other types or packet networks instead of an Ethernet (IEEE 802.3) physical layer. Some examples of alternate physical payers for other embodiments may include, but are not limited to, Wi-Fi (IEEE 802.11) wireless networks and token-ring (IEEE 802.2) networks.

For the example of FIG. 1, which only aggregates outbound links connecting Network Node 1 to the WAN, Packet Routing Unit 1012 of Packet Processor 101 rewrites Ethernet media access control (MAC) hardware destination addresses corresponding to the Ethernet addresses of each of the DSL Modem Links 3. With the appropriate Ethernet destination address thus inserted into each packet, packets destined for the same IP address of Receiving Network Node 5 travel through different routes through each of the DSL Modems 3 comprising the virtual link aggregate in arriving at IP WAN Network 4.

FIG. 2 shows an embodiment of the invention that implements virtual link aggregation for inbound links from an IP Wide-Area Network 4 to a Receiving Network Node 5. In this example, DSL Modems 6 receive packets from WAN 4 and forward them to Receiving Network Node 5 through Ethernet Switch 7. As in FIG. 1, DSL Modems 6 may include any type and number of WAN links, including but not limited to, cable modems, cellular data modems, DS-1 lines, broadband wireless modems, and ISDN lines, or any combination of different types of links. Also as in FIG. 1, a repeater or hub or even multiple Ethernet ports on Receiving Network Node 5 may replace Ethernet Switch 7. In contrast with the virtual link aggregation of FIG. I that rewrites Ethernet hardware destination addresses to route packets to the appropriate modem 3, the receive-side virtual link aggregation of FIG. 2 rewrites destination IP addresses to send each packet to targeted modem 6.

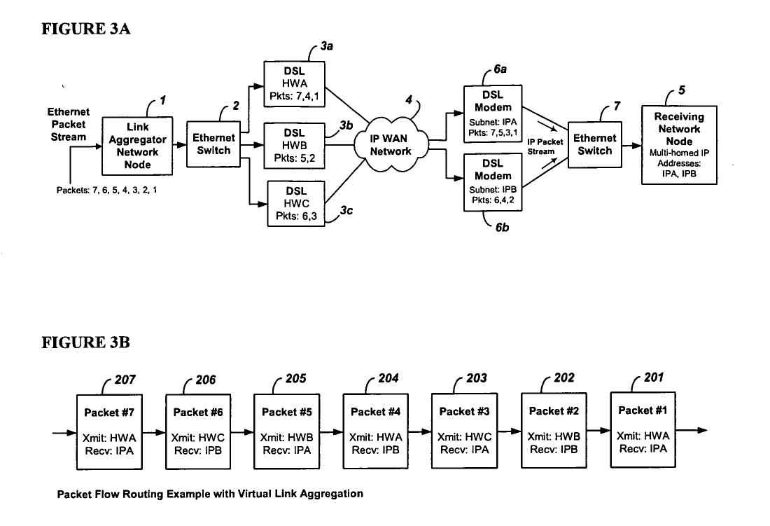

FIG. 3A provides a full example of an embodiment of the invention that combines both the hardware address routing of FIG. I with the IP routing downstream of FIG. 2 to provide virtual link aggregation for both upstream and downstream packets. This example assumes that all WAN links have equal data rates and all packets are the same length. In FIG. 3A, and as shown as a packet flow diagram of FIG. 3B, a sequential stream of packets, labeled I through 7 enter the Link Aggregator of Network Node 1. These packets pass through Ethernet Switch 2 and are routed to DSL Modems 3a, 3b, and 3c because of the hardware address routing of the Link Aggregator of Network Node 1. Without the link aggregator of this invention, all packets would typically be routed to one particular DSL modem, say 3a. However, as a result of Link Aggregator of Network Node 1, DSL Modem 3a receives and then forwards packets 1, 4, and 7 to IP WAN Network 4; DSL Modem 3b receives and sends packets 2 and 5; and DSL Modem 3c handles packets 3 and 6 to IP WAN 4, thereby redistributing the load roughly equally among all 3 outbound WAN links.

More specifically, in this example Modem 3a has hardware address HWA; Modem 3b has address HWB; and Modem 3c has address HWC. Therefore, the Load Balancing and Link Selector of Link Aggregator of Network Node 1 changes the destination address of packets 1, 4, 7 to HWA; sets address HWB for packets 2 and 5; and HWC for packets 3 and 6. The modems forward the packets onto IP WAN Network 4 because their IP destination addresses require a route through the WAN. The load balancing algorithm may choose this distribution of packets as one attempt at equalizing the loading among the three upstream links. However, other load balancing algorithms might choose a different distribution of packet routing (for example if one modem is faster than the other modem(s) being used).

In routing for the downstream side, the Link Aggregator of Network Node I rewrites the IP destination addresses of packets 1, 3, 5, and 7 to point to IP address IPA of Receiving Network Node 5. However in this example, IPA is part of a subnet handled by DSL Modem 6a, so that by having destination address IPA, these packets will be routed through DSL Modem 6a. Similarly, the link aggregator gives packets 2, 4, and 6 IP address IPB so that these packets will travel through Modem 6b on route to their final destination of IP address IPB at Receiving Network Node 5.

In another embodiment, DSL Modems 6a and 6b may have port forwarding capabilities. In this case, addresses IPA and IPB point to Modems 6a and 6b, respectively, as their IP destination. However, the original source of these packets set the UDP or TCP ports to a well-known or pre-assigned port number. The port forwarding mechanism of Modems 6a and 6b, upon finding a match in their port forwarding tables, forwards these packets to Receiving Network Node 5.

Different links may have different propagation delays, resulting in a reordering of packets at Receiving Network Node 5. However some applications, such as media streaming, may be sensitive to any changes from the original packet sequence. In such applications where packet order is important, and where provisions have not been made at the application level to restore packet order, embodiments of the invention may include a buffering mechanism at Receiving Network Node 5 to restore the original packet order.

In addition to packet reordering concerns, different links may have different levels of packet loss or congestion-induced packet arrival jitter. Combining links with increased levels of such packet impairments along side more reliable links can lower the overall service quality of the aggregate link. Thus, in such cases where an application may be sensitive to these sorts of network impairments, and where such an application may not otherwise incorporate a means for compensating for these packet impairments, Receiving Network Node 5 may include more comprehensive quality of service (QoS) restoration mechanisms in addition to or in place of a packet buffer that restores packet order. The design and implementation of such QoS mechanisms has been the subject of much outside work, including U.S. Provisional Patent Application Ser. No. 60/521821, 60/521904, and 60/522063 and U.S. Utility patent application Ser. Nos. 11/177,507, 11/184,486 and 11/184,485 which are used in combination with embodiments of the invention and which are hereby incorporated herein by reference.

Conversely, some embodiments of this invention may also rely only upon application-level mechanisms for overcoming QoS network impairments, or alternatively, not require any such QoS mechanisms at all, and may therefore not include any such additional packet buffering, packet retiming, synchronization, or packet loss recovery mechanisms.

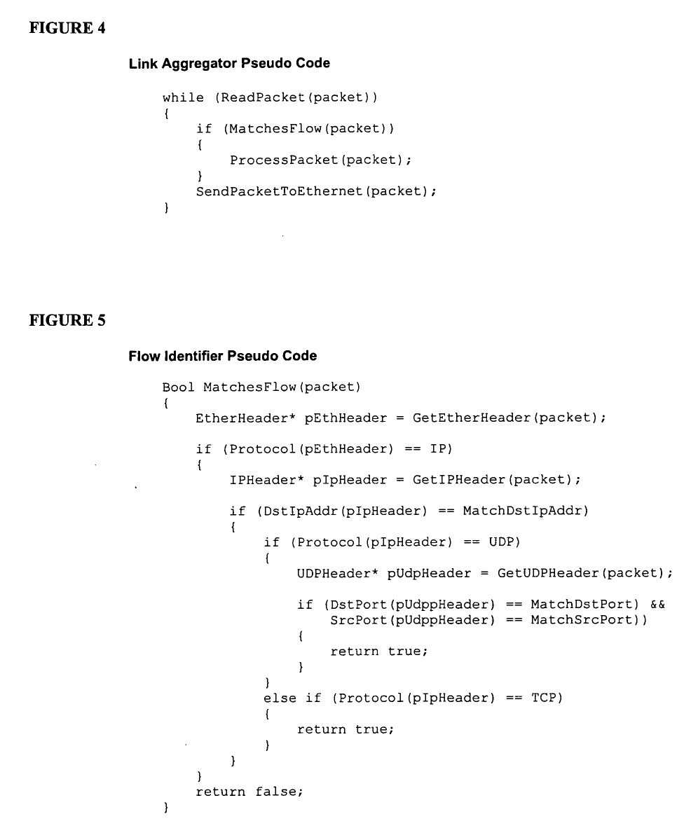

Through the use of pseudo-code, FIGS. 4 through 7 provide a detailed example of the workings of one possible embodiment of the invention. FIG. 4 shows the basic operation of a Link Aggregator 10 (see FIGS. 1-2 for reference numbers listed herein), wherein packets are processed as they arrive, first being read by a ReadPacket( ) function. Next a MatchesFlow( ) function checks whether the current packet matches a flow configured in FlowIdentifier 100. Packets that do not match go directly to the SendPacketToEthernet( ) function, while packets matching selected flows proceed to a ProcessPacket( ) routine that balances loading and rewrites packet header addresses for rerouting according to the virtual link aggregation of this invention.

FIG. 5 shows the pseudo-code for the MatchesFlow( ) function that comprises the optional Flow Identifier 100 of FIG. 1. In this embodiment, Flow Identifier 100 only matches UDP/IP packets that match specified source and destination port numbers as being part of a flow, and matches all TCP/IP packets for routing over a particular pre-selected link. MatchesFlow( ) immediately bypasses all other packet types, such as ARP and ICMP/IP.

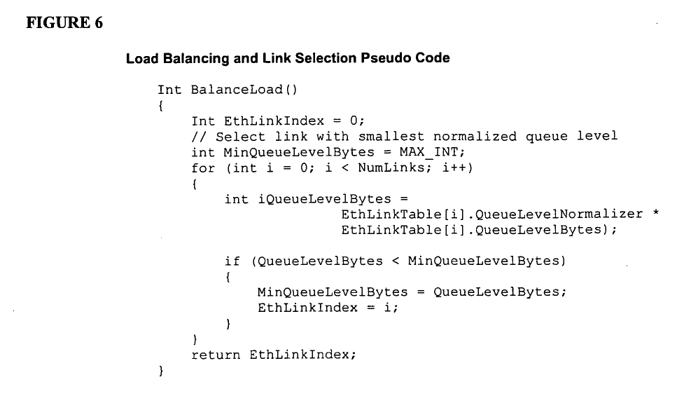

FIG. 6 lists the pseudo-code for one possible implementation for function BalanceLoad( ), which comprises Load Balancing and Link Selector Unit 1011. BalanceLoad( ) selects the link having the lowest current load using updated information that models the queue level in each WAN link of the virtual link aggregation. For the particular embodiment in the examples of FIGS. 1-3 having DSL Modems, BalanceLoad( ) compares queue levels for DSL Modems 3a, 3b, and 3c for upstream WAN link aggregation and DSL Modems 6a and 6b for downstream links aggregation.

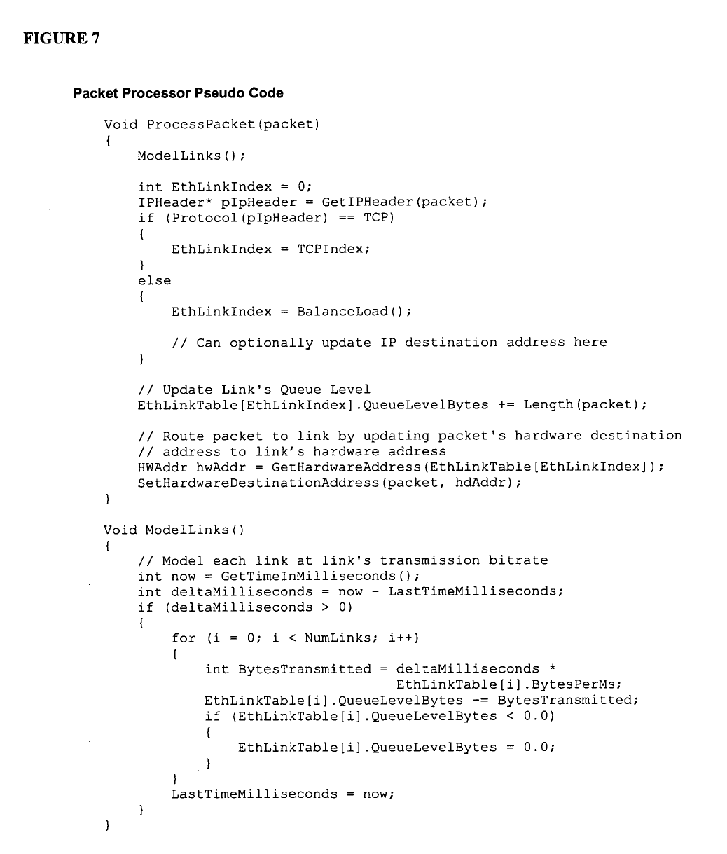

FIG. 7 shows the pseudo-code implementing one possible embodiment of a ProcessPacket( ) function comprising Packet Processor 101 of FIG. 1. ProcessPacket( ) first calls ModelLinks( ) to update link status using, in this embodiment, a model of the current loading state for each link. Other embodiments might employ a direct means of inquiring the current status of each link, which may include an operational state (up or down) and queue loading state for each link. For packets that have been selected as being part of a flow, ProcessPacket( ) then calls BalanceLoad( ) to select the appropriate link for upstream link aggregation. ProcessPacket( ) then rewrites the Ethernet hardware destination address for the packet being processed to finalize the packet's route.

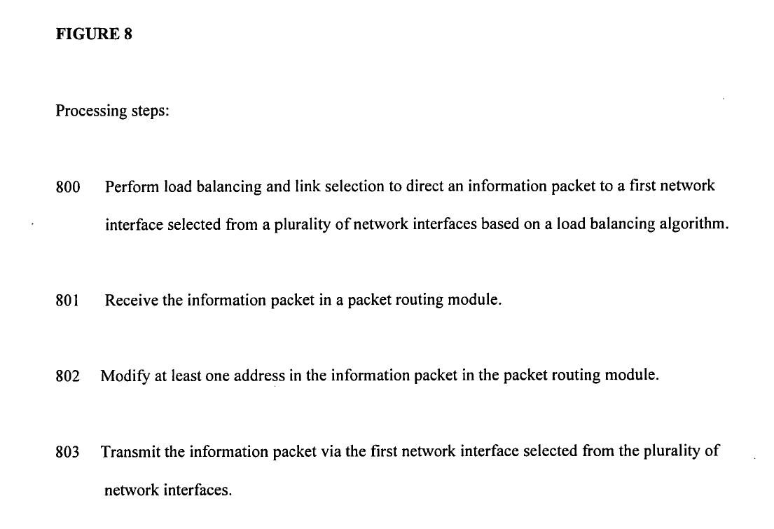

FIG. 8 shows processing steps for an embodiment of the invention. Load balancing and link selection is performed to direct an information packet to a first network interface selected from a plurality of network interfaces based on a load balancing algorithm at 800. An information packet is received in the packet routing module at 801. At least one address is modified in the information packet via the packet routing module at 802. The information packet is transmitted via the first network interface selected from the plurality of network interfaces employed in the transmission side of the system. When using a high level addressing scheme (i.e., when at least one address in the information is a high level address that is modified), a plurality network interfaces of the receive side may be used (for example when setting a machine to look for multiple IP addresses) and in this manner the receive side may make use of multiple network interfaces to increase throughput.

In view of the wide variety of embodiments to which the principles of the invention can be applied, it should be understood that the illustrated embodiments are exemplary only, and should not be taken as limiting the scope of embodiments of the invention. For example, the packet ordering and grouping of the media packet stream flow of FIG. 3A and 3b may be taken in sequences other than those described, and more or fewer elements or components may be used in the block diagrams. In addition, the present invention can be practiced with software, hardware, or a combination thereof. For example, modules may be implemented in software, hardware or a combination.

The claims should not be read as limited to the described order or elements unless stated to that effect. Therefore, all embodiments that come within the scope and spirit of the following claims and equivalents thereto are claimed as the invention.

### References

(1) G. O. Thompson et. al., “802.3ad™-2000 (Clause 43), Aggregation of Multiple Link Segments,” URL: http://standards.ieee.org/getieee802/download/802.3-2002.pdf, IEEE-Std 802.3™-2002, The Institute of Electrical and Electronics Engineers (IEEE), 8 Mar. 2002.

(2) L. Magalhaes and R. Kravets, “MMTP: multimedia multiplexing transport protocol,” URL:http://portal.acm.org/citation.cfm?id=844207&coll=ACM&dl=ACM&CFID=3 0091247&CFTOKEN=95402952, ACM SIGCOMM Computer Communication Review, Volume 31 Issue 2 Supplement, April 2001, page 220-243.

(2) A. Ananthaswamy, “Spontaneous Networks will Speed Net Access,” URL: http://www.newscientist.com, ACM Computer Communications Review, 2001.

What is claimed is:

1. A system for the virtual aggregation of network links comprising:
a load balancing and link selection module configured to direct an information packet to a first network interface selected from a plurality of network interfaces based on a load balancing algorithm;
a packet routing module configured to accept said information packet from said load balancing and link selection module and modify at least one address in said information packet for transmission via said first network interface selected from said a plurality of network interfaces; and,
a packet processor comprising said packet routing module and said load balancing and link selection module.

2. The system of claim 1 wherein said at least one address is a low level address comprising a media access control address.

3. The system of claim 1 wherein said at least one address is a high level address comprising a destination IP address.

4. The system of claim 1 wherein said at least one address is a low level address comprising a media access control address and a high level address comprising a destination IP address.

5. The system of claim 4 wherein said high level address comprises a port number.

6. The system of claim 1 further comprising:
a flow identifier module configured to determine if said information packet should bypass said packet processor;
a link aggregator comprising said packet processor; and,
said link aggregator further comprising said flow identifier module wherein a first output of said flow identifier module is coupled with an input of said load balancing and link selection module and a second output of said flow identifier module is configured to bypass said load balancing and link selection module.

7. The system of claim 6 wherein said at least one address is a low level address comprising a media access control address.

8. The system of claim 6 wherein said at least one address is a high level address comprising a destination IP address.

9. The system of claim 6 wherein said at least one address is a low level address comprising a media access control address and a high level address comprising a destination IP address.

10. The system of claim 9 wherein said high level address comprises a port number.

11. A method for the virtual aggregation of network links comprising:
load balancing and performing link selection to direct an information packet to a first network interface selected from a plurality of network interfaces based on a load balancing algorithm;
receiving said information packet in a packet routing module;
modifying at least one address in said information packet in said packet routing module; and, transmitting said information packet via said first network interface selected from said a plurality of network interfaces.

12. The method of claim 11 wherein said modifying said at least one address comprises modifying a low level address comprising a media access control address.

13. The method of claim 11 wherein said modifying said at least one address comprises modifying a high level address comprising a destination IP address.

14. The method of claim 11 wherein said modifying said at least one address comprises modifying a low level address comprising a media access control address and modifying a high level address comprising a destination IP address.

15. The method of claim 14 wherein said modifying said high level address comprises modifying a port number.

16. The method of claim 11 further comprising:
determining if said information packet should bypass said packet processor via a flow identifier module; and,
bypassing a load balancing and link selection module.

17. The method of claim 16 wherein said modifying said at least one address comprises modifying a low level address comprising a media access control address.

18. The method of claim 16 wherein said modifying said at least one address comprises modifying a high level address comprising a destination IP address.

19. The method of claim 16 wherein said modifying said at least one address comprises modifying a low level address comprising a media access control address and modifying a high level address comprising a destination IP address.

20. The method of claim 19 wherein said modifying said high level address comprises modifying a port number.
